(19) United States
(12) Patent Application Publication
(10) Pub. No.: US 2025/0093541 A1
(43) Pub. Date: Mar. 20, 2025

(54) WAVEFIELD TRAVELTIME INVERSION WITH AUTOMATIC FIRST ARRIVAL FILTERING

(71) Applicant: SAUDI ARABIAN OIL COMPANY, Dhahran (SA)

(72) Inventors: Young Seo Kim, Dhahran (SA); Ali Ameen Almomin, Dammam (SA); Tong W. Fei, Dhahran (SA)

(73) Assignee: SAUDI ARABIAN OIL COMPANY, Dhahran (SA)

(21) Appl. No.: 18/470,387

(22) Filed: Sep. 19, 2023

(51) Int. Cl. G01V 1/34; E21B 49/00; G01V 1/28; G01V 1/30

(52) U.S. Cl. CPC G01V 1/345; E21B 49/00; G01V 1/282; G01V 1/303; G01V 2210/66

(57) ABSTRACT

Examples of methods and systems are disclosed. The methods may include obtaining, using a seismic processing system, seismic data regarding a subsurface region of interest and determining a plurality of first arrivals based on the seismic data. The methods may also include determining, using the seismic processing system, a plurality of filtered first arrivals by applying a modal filter and replacement interpolation to the plurality of first arrivals, and generating a seismic image based, at least in part, on the plurality of filtered first arrivals.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and may store a time-series of samples of earth motion caused by the seismic waves. The collection of time-series of samples recorded at many receiver locations generated by a seismic source at many source locations constitutes a seismic data set.

To determine the earth structure, including the presence of hydrocarbons, the seismic data set may be processed. Processing a seismic data set includes a sequence of steps designed to correct for a number of issues, such as near-surface effects, noise, irregularities in the seismic survey geometry, etc. Seismic data may be also processed with inversion techniques to generate high resolution images of subsurface regions to assist in identification of fine geological features. A properly processed seismic data set may aid in decisions as to if and where to drill for hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method. The method includes obtaining, using a seismic processing system, seismic data regarding a subsurface region of interest and determining a plurality of first arrivals based on the seismic data. The method also includes determining, using the seismic processing system, a plurality of filtered first arrivals by applying a modal filter and replacement interpolation to the plurality of first arrivals and generating a seismic image based, at least in part, on the plurality of filtered first arrivals.

In general, in one aspect, embodiments disclosed herein relate to a system. The system includes a seismic processing system and a seismic interpretation system. The seismic processing system is configured to obtain seismic data regarding a subsurface region of interest and determine a plurality of first arrivals based on the seismic data. The seismic processing system is further configured to determine a plurality of filtered first arrivals by applying a modal filter and replacement interpolation to the plurality of first arrivals, and generate a seismic image based, at least in part, on the plurality of filtered first arrivals. The seismic interpretation system is configured to receive the seismic image and to determine a drilling target in the subsurface region based, at least in part, on the seismic image.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 shows a seismic acquisition system of a subsurface region of interest, according to one or more embodiments of the present disclosure.

FIG. 2 shows examples of seismic data produced by a seismic acquisition system in accordance with one or more embodiments.

FIG. 3 shows an example of a seismic data in a common depth-point domain, according to one or more embodiments.

FIG. 4 shows examples of statistical distributions.

FIG. 5 shows a drilling system in accordance with one or more embodiments.

FIG. 6 shows a flowchart in accordance with one or more embodiments.

FIG. 7 shows a flowchart in accordance with one or more embodiments.

FIG. 8 shows examples of filtered first arrivals, according to one or more embodiments.

FIG. 9 shows examples seismic data with filtered first arrivals in a common depth-point domain, according to one or more embodiments.

FIG. 10 shows examples of seismic velocity models, according to one or more embodiments.

FIG. 11 shows examples of seismic velocity models, according to one or more embodiments.

FIG. 12 shows examples of seismic images, according to one or more embodiments.

FIG. 13 depicts a schematic diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

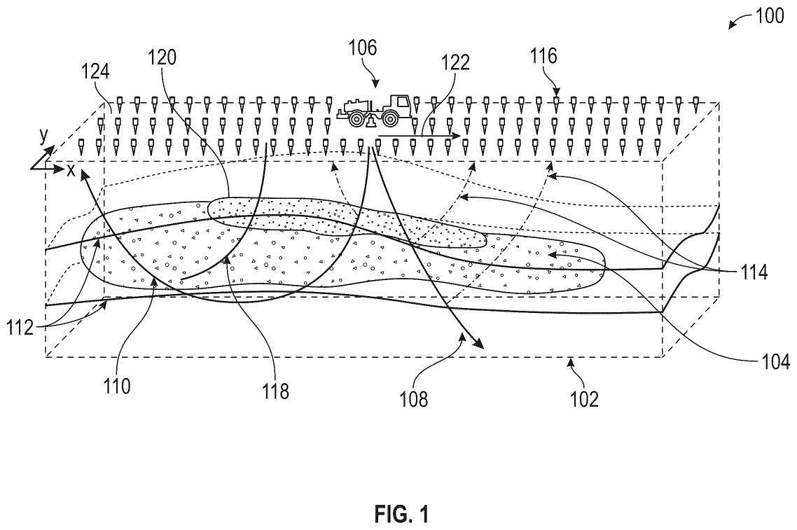

In the following description of FIGS. 1-13, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods to generate seismic images with automatic filtering of first arrivals. In particular, some embodiments acquire seismic signals during geophysical explorations to map the structure of a subsurface region. The seismic signals may be composed of diffracted and/or reflected seismic energy, due to the presence of discontinuities, subsurface interfaces, and/or diffractors among other geological features. Seismic imaging techniques aim at recovering the geological features from recorded seismic data.

Wavefield traveltime inversion (WTI) methods are commonly used to generate seismic velocity models, because of their capabilities to generate high resolution models, in particular in in-land explorations, where the near-surface structure may be complex. However, WTI methods include optimizing algorithms that are iterative and with non-unique solutions. WTI methods with reduced number of iterations and reduced number of possible solutions may also result in seismic velocity models of higher accuracy. Since generating the seismic velocity model may be an intermediate step in the generation of seismic images, the accuracy of the seismic velocity model has a significant impact on the generated seismic images. Thus, methods and processing techniques to improve the accuracy of velocity models may assist in improving the efficiency of methods to generate seismic images.

The resulting seismic image may then be used for seismic data interpretation, such as defining the spatial location and extent of a hydrocarbon reservoir. Thus, the disclosed methods are integrated into the established practical applications for improving seismic images and searching for an extraction of hydrocarbons from subsurface hydrocarbon reservoirs. The disclosed methods represent an improvement over existing methods for at least the reasons of lower cost and increased efficacy.

FIG. 1 shows a seismic acquisition system (100) of a subsurface region of interest (102), according to one or more embodiments. In some cases, the subsurface region of interest (102) may lie beneath a lake, sea, or ocean. In other cases, the subsurface region of interest (102) may lie beneath an area of dry land. The subsurface region of interest (102) may contain a hydrocarbon deposit (120) that may form part of a hydrocarbon reservoir (104). The seismic acquisition system (100) may utilize a seismic source (106) that generates radiated seismic waves (108). The type of seismic source (106) may depend on the environment in which it is used. For example, on land the seismic source (106) may be a vibroseis truck or an explosive charge, but in water the seismic source (106) may be an airgun. The radiated seismic waves (108) may return to the surface as refracted seismic waves (110) or reflected seismic waves (114). Seismic receivers may record particle velocity along up to three orthogonal component axes (geophones), or record particle acceleration along up to three orthogonal component axes (accelerometers), or pressure fluctuation (particularly when disposed in water) caused by the reflected and refracted seismic waves.

Refracted seismic waves (110) and reflected seismic waves (114) may occur, for example, due to geological discontinuities (112) that may be also known as “seismic reflectors”. The geological discontinuities (112) may be, for example, planes or surfaces that mark changes in physical or chemical characteristics in a geological structure. The geological discontinuities (112) may also be boundaries between faults, fractures, or groups of fractures within a rock. The geological discontinuities (112) may delineate a hydrocarbon reservoir (104).

At the surface, refracted seismic waves (110) and reflected seismic waves (114) may be detected by seismic receivers (116). Radiated seismic waves (108) that propagate from the seismic source (106) directly to the seismic receivers (116), known as direct seismic waves (122), are also detected by the seismic receivers (116).

In some embodiments, a seismic source (106) may be positioned at a location denoted (xₛ, yₛ), where x and y represent orthogonal axes on the earth's surface above the subsurface region of interest (102). The seismic receivers (116) may be positioned at a plurality of seismic receiver locations denoted (xᵣ, yᵣ), with the distance between each receiver and the source being termed “the source-receiver offset”, or simply “the offset”. Thus, the direct seismic waves (122), refracted seismic waves (110), and reflected seismic waves (114) generated by a single activation of the seismic source (106) may be represented in the axes (xₛ, yₛ, x, yᵣ, t). The t-axis indicates the recording time between the activation of the seismic acquisition system (100) and the sample time at which the seismic wave is detected by the seismic receivers (116).

Seismic processing may reduce five-dimensional seismic data produced by a seismic acquisition system (100) to three-dimensional (x, y, t) seismic data by, for example, correcting the recorded time for the time of travel from the seismic source (106) to the seismic receiver (116) and summing (“stacking”) samples over two horizontal space dimensions. Stacking of samples over a predetermined time interval may be performed as desired, for example, to reduce noise and improve the quality of the signals.

Seismic data may also refer to data acquired at different time intervals, such as, for example, in cases where seismic surveys are repeated after a period of weeks, months, or years, to obtain time-lapse data. Seismic data may also be pre-processed or partially-processed data, e.g., arranged as “common shot gathers” (CSG), i.e., sorting waveforms as acquired by different receivers and having a single source location. The type of seismic data is not intended as limiting, and any other suitable seismic data is intended to fall within the scope of the present disclosure.

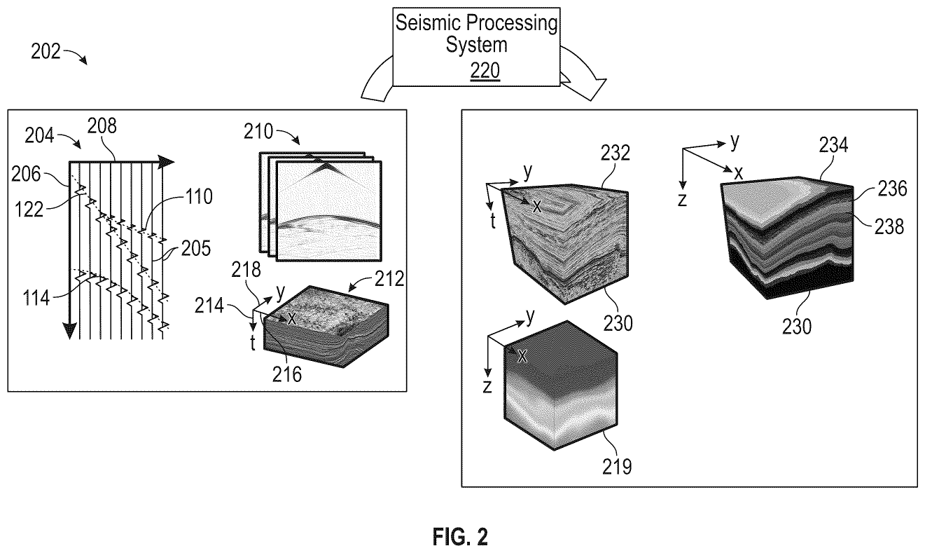

FIG. 2 shows examples of seismic data (202) produced by a seismic acquisition system (100) in accordance with one or more embodiments. An example of a CSG (204) depicts direct seismic waves (122), refracted seismic waves (110), and reflected seismic waves (114) generated by a single activation of the seismic source (106) and recorded by a plurality of seismic receivers (116) deployed, for example in a line, on the surface of the earth. Each seismic receiver (116) may record a time-series representing the amplitude of ground-motion at a sequence of discrete times. This time-series may be denoted or otherwise referred to as a “waveform”. Seismic data therefore may include a plurality of time-space waveforms (205) associated to the plurality of seismic receivers (116).

In the CSG (204) shown in FIG. 2 the vertical axis represents the time scale (206) and the horizontal axis represents the offset (208). In some embodiments, direct seismic waves (122), refracted seismic waves (110), and reflected seismic waves (114) may be identified in the CSG (204) by their arrival times, i.e., the times at which they are first detected by the seismic receivers (116). The location of a particular type of wave in seismic data (202) acquired in time and space, such as in CSG (204), may be termed as an “arrival” or as an “event”.

The CSG (204) illustrates how the arrivals are detected at later times by the seismic receivers (116) that are farther from the seismic source (106). In some embodiments, arrivals of direct seismic waves (122) in the CSG (204) may be characterized by a straight line, while arrivals of reflected seismic waves (114) may present a hyperbolic shape, as seen in FIG. 2. Refracted seismic waves (110) may be characterized by arrivals approximating a straight line in offset-time.

In one or more embodiments, seismic data (202) acquired by a seismic acquisition system (100) may be arranged in a plurality of CSGs (210) to create a 3D seismic dataset. Alternatively, the seismic data may be represented as a “seismic volume” (212) consisting of a plurality of time-space waveforms with a time axis (214), a first spatial dimension (216), and a second spatial dimension (218), where the first spatial dimension (216) and second spatial dimension (218) are orthogonal and span the Earth's surface above the subsurface region of interest (102).

Seismic data (202) may be processed by a seismic processing system (220). Processing seismic data (202) may consist of several key groups of functions, each serving a specific purpose in the processing workflow. For example, the steps may include data injection, the loading, sorting and arrangement of raw seismic data, acquired from various sources such as seismographs or land-based sensors, into the processing system. This data may include seismic waveforms, and may also include well logs, and survey information.

Data quality control is critical in seismic processing. A seismic processing system (220) employs various tools and techniques to identify and correct any artifacts, noise, or errors in the data. This step ensures the accuracy and reliability of subsequent processing steps.

Further, the raw seismic data may be “conditioned”, i.e., the raw seismic data is pre-processed to enhance its quality and make it suitable for further analysis. This step may include procedures such as filtering, deconvolution, noise suppression, and signal enhancement.

In addition, data may be “stacked”. Stacking involves combining multiple seismic traces to improve data quality and increase signal-to-noise ratio. This may enhance the identification of subsurface features and reduces random noise interference.

Velocity analysis is crucial for accurate imaging and interpretation of subsurface structures. It involves estimating the time-depth relationship of seismic reflections and determining the velocity model of the subsurface. The seismic processing system (220) will provide methods for multiple methods of performing velocity analysis, including normal moveout analysis, iterative Kirchhoff time- and depth-migration, tomography, and full waveform inversion.

Migration is a key step that transforms the processed seismic data from the time domain to the depth domain, providing a more accurate representation of subsurface structures. It helps in locating and positioning geological features accurately.

The seismic processing system (220) may provide visualization tools to render the seismic data in a visual format, enabling geoscientists to analyze, interpret, and perform visual quality control more effectively. This can include 2D/3D seismic displays, depth slices, horizon maps, and virtual reality visualization.

The final step involves generating reports and documenting the results of the seismic processing workflow. This includes recording the processing parameters, interpretation results, and any uncertainties or limitations associated with the data processing. The seismic processing system (220) is required to perform these groups of steps for even a small commercial seismic survey.

The seismic processing system (220) may consist of various hardware components that work together to process and analyze seismic data. Seismic processing requires significant computational power and storage capacity. High-performance servers and workstations are used to handle the massive amount of data and perform complex processing algorithms efficiently. Seismic data can be massive, reaching terabytes or even petabytes in size. Reliable and high-capacity storage systems, such as Network Attached Storage (NAS) or Storage Area Networks (SAN), are utilized to store and manage the seismic data effectively.

In some cases, where processing demands are extremely high, the seismic processing system (220) may utilize cluster systems. Clusters are groups of interconnected computers or servers that work together to distribute the processing workload, enabling parallel processing and faster data analysis. A robust and high-speed network infrastructure is vital for seamless data transfer between different components of the seismic processing system (220). This ensures efficient communication and data sharing, especially in multi-node or distributed processing environments.

The seismic processing system (220) may use GPUs for accelerating the computation of seismic processing algorithms. Their parallel processing capabilities significantly speed up tasks such as migration, inversion, and visualization. Despite advances in storage technology, data on tapes is still often used for long-term archiving and backup purposes. Tape systems provide high-capacity, cost-effective, and reliable storage solutions for seismic data. Various peripherals such as monitors, keyboards, mice, network switches, uninterruptible power supply (UPS), and backup power generators complete the hardware setup of a seismic processing system (220). These peripherals ensure smooth operation, user interaction, and data integrity.

The software/firmware are at least as integral a part of the seismic processing system (220) as the hardware components and a seismic processing system (220) equipped with a unique software program is at least as distinctively different from other seismic processing systems without the unique software program as a seismic processing system (220) with GPUs is different from one without GPUs.

Seismic data (202) may be processed by a seismic processing system (220) to generate a seismic velocity model (219) of the subterranean region of interest (102). A seismic velocity model (219) is a representation of seismic velocity at a plurality of locations within a subterranean region of interest (102). Seismic velocity is the speed at which a seismic wave, that may be a pressure-wave or a shear-wave, travel through a medium. Pressures waves are often referred to as “primary-waves” or “P-waves”. Shear waves are often referred to a “secondary-waves” or “S-waves”. Seismic velocities in a seismic velocity model (219) may vary in vertical depth, in one or more horizontal directions, or both. Layers of rock are created from different materials or created under varying conditions. Each layer of rock may have different physical properties from neighboring layers and these different physical properties may include seismic velocity.

FIG. 2 schematically illustrates that in some embodiments seismic data (202) may be processed by a seismic processing system (220) to generate a seismic image (230) of the subterranean region of interest (102). For example, a time-domain seismic image (232) may be generated using a process called seismic migration (also referred to as simply “migration” herein) using a seismic velocity model (219). In seismic migration, seismic events (e.g., reflections, refractions) recorded at the surface are relocated in either time or space to the location the event occurred in the subsurface. In some embodiments, migration may transform pre-processed shot gathers from a time-domain to a depth-domain seismic image (234). In a depth-domain seismic image (234), seismic events in a migrated shot gather may represent geological boundaries (236, 238) in the subsurface. Various types of migration algorithms may be used in seismic imaging. For example, one type of migration algorithm corresponds to reverse time migration.

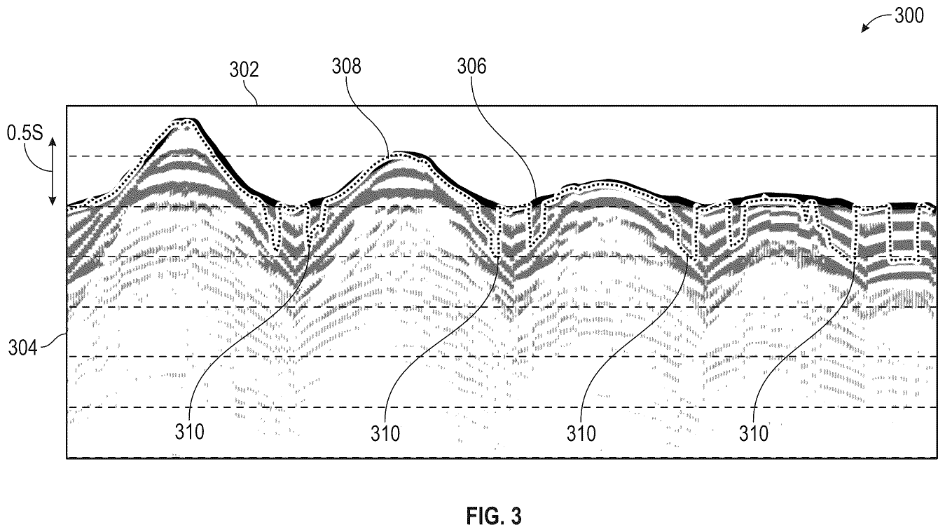

One of the steps employed early in the processing of seismic data (202) is to pick the arrival-time of a first arriving event for each seismic trace, which may be referred to as a “first arrival”. FIG. 3 shows a two-dimensional common depth-point (CDP) gather of seismic data (300). In FIG. 3 the abscissa (horizontal axis) indicates receiver number (302) and the ordinate (vertical axis) is time, t (304). The first arrival (308) for each seismic trace is shown in FIG. 3 by the dotted line running from left to right across the plot.

The first arrivals (306) may be used to estimate and compensate for “statics”, i.e., perform “statics correction”. Statics may be caused, without limitation, by localized changes in the elevation of the ground surface on which the seismic data (202) is collected, and localized changes of the seismic velocity close to the surface. In addition, the first arrivals (306) may be used in steps later in the processing the seismic data (202), such as in determining seismic velocity models (219).

Many methods of picking the first arrivals (306) in seismic data (202) are familiar to one of ordinary skill in the art. For example, picking first arrivals (306) may be based upon variations in the energy ratio of time-windows of different length along the time-space waveform (205). In addition, methods for picking first arrivals (306) based upon machine learning algorithms have been proposed.

In some embodiments, first arrivals (306) in seismic data (202) may be picked using the Modified Energy Ratio (MER) method, whereby an energy ratio, M, is computed for each time-space waveform (205), as:

$$M ( t ) = {\{ ( {\sum }_{i = t}^{t + {n}_{e}} \vert {s}_{i}^{2} \vert / {\sum }_{i = t - {n}_{e}}^{t} \vert {s}_{i}^{2} \vert ) \vert {s}_{i} \vert \}}^{3} \qquad Equation ( 1 )$$

where t is a time index, sᵢ is the amplitude of the seismic trace at the i-th time index, and ne is the number of time samples in a moving time-window before and after the time t. The first arrival (306) for each time-space waveform (205) may then be identified as the time at which M attains its maximum value. The MER method may be applied to real seismic data (202) acquired over subterranean regions of interest (102) to find the first arrivals (306). If the signal-to-noise ratios (SNR) of the time-space waveforms (205) are good, then any of the methods for picking first arrivals (306) familiar to one of ordinary skill in the art, may give a result of adequate accuracy. However, in seismic data (202) where at least some of the time-space waveforms (205) have low SNR existing methods, including the MER method, when used alone may not give results of adequate accuracy.

In some embodiments a method of picking first arrivals (306) in seismic data (202) may be combined with a method for estimating first arrivals (306) in a simulated seismic data set calculated for a seismic velocity model to yield a result of adequate accuracy.

The velocity of seismic wave propagation may vary with depth below the surface and may vary with horizontal spatial position within the subterranean region of interest (102). Seismic wave velocity may be determined from seismic data (202) acquired by a seismic acquisition system (100) above the subterranean region of interest (102). The determination of the seismic wave velocity may be achieved using a number of methods well known to one of ordinary skill in the art. For example, where seismic wave velocity is invariant with horizontal position, seismic normal moveout analysis may be appropriate. In cases where seismic wave velocity varies only slowly with horizontal position, iterative Kirchhoff migration, or iterative one-way wave propagation migration may be used. In cases where seismic wave velocity varies rapidly with horizontal position, tomographic or waveform inversion methods are most appropriate.

WTI methods measured seismic data to generate a seismic velocity model (219) of a subsurface region of interest (102). WTI methods start with an initial estimate of the seismic velocity model (219) for the region of interest (102) surrounding the seismic source (106) and the seismic receivers (116). The model may vary as a function of spatial position. The initial seismic velocity model is updated iteratively as part of the inversion procedure.

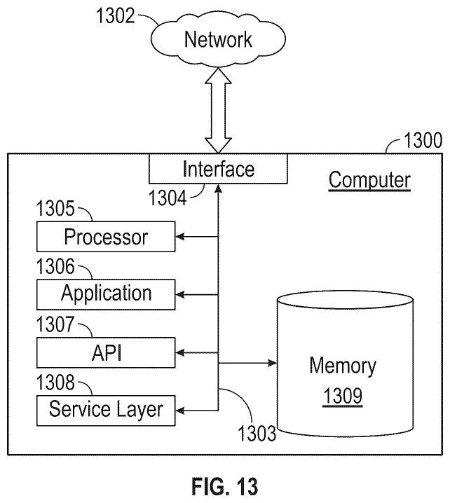

Updating the seismic velocity model (219) may involve the modeling or numerical simulation of the seismic wave propagation in the subsurface region of interest (102). WTI methods use the elastic wave equation, or a simplified version of the elastic wave equation, such as the acoustic wave equation or Helmholtz wave equation, to model the propagation of seismic waves within the subsurface region of interest (102), based at least in part on the initial seismic velocity model. Simulation of the seismic waves measured by seismic receivers (116), e.g., a plurality of observed time-space waveforms (205), may generate corresponding simulated time-space waveforms. In some embodiments, the modeling or seismic wave propagation and generation of simulated time-space waveforms may be done by a computer system (1300) as the one described in FIG. 13.

The simulated time-space waveforms and the observed time-space waveforms (205) may then be compared and a function, denoted as an “objective function”, may be calculated to quantify the difference between simulated time-space waveforms and the observed time-space waveforms (205). In particular, in WTI, the objective function may be defined by the time difference of first arrivals (306) of the observed time-space waveforms (205) and the first arrivals (306) of the simulated time-space waveforms as follows:

$$E ( m ) = \frac{1}{2} {\sum }_{j = 1}^{{n}_{r}} {‖ {F}_{u , j} ( m ) - {F}_{d , j} ‖}^{2} = \frac{1}{2} {\sum }_{j = 1}^{{n}_{r}} {‖ Δ {t}_{j} ‖}^{2} \qquad Equation ( 2 )$$

where nᵣ is the number of receivers and m is a subsurface P-wave velocity. The times F_{u,j} and F_{d,j} are first arrivals (306) at the j receiver picked from simulated time-space waveforms and the observed time-space waveforms (205), respectively. On the right-hand side of Equation 2, Δt₁ is the time difference between the first arrivals F_{u,j} and F_{d,j}. First arrivals (306) are computed in iterative manner until the error related to the misfit function is below acceptable levels. The objective function E(m) may be minimized by calculating an update to the seismic velocity model (219) within the region of interest (102).

The MER method, as given in Equation (1) above is known to be provide adequate results when applied to pick first arrivals (306) from simulated seismic data, which may be practically considered as noise-free data. However, when the near surface seismic velocity model is complex, reflected seismic waves (108) and refracted seismic waves (110) are highly likely to arrive at the same time, and the MER algorithm may misidentify a late event as a first arrival (306). The misidentification may take place after many iterations. Examples of misidentification of first arrivals (306) are shown for the simulated CDP gather in FIG. 3. The dotted line indicates the first arrivals identified with the MER algorithm, the “MER first arrivals” (308). As seen, because of the complexity of the wavefield, the MER algorithm misidentified late events as first arrivals at several locations, for example at locations (310). At locations (310) the amplitude of late arrivals is much higher than the amplitude of the true first arrivals.

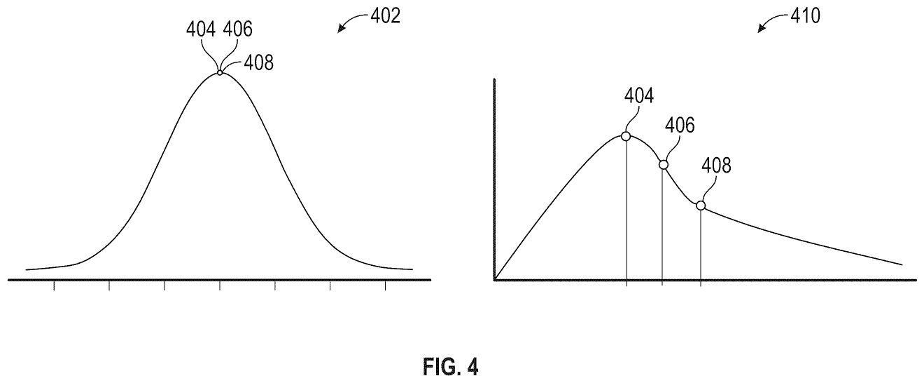

In some embodiments, the simulated first arrivals (308) may be statistically analyzed and filtered using a modal filtered, i.e., using the concept of “mode” as filtering criterion. The “mode” in statistics means the most frequent value in a set of data values. In a normal distribution, such as that shown in panel (402) of FIG. 4, measures of central tendency such as the mode (404), the mean (406), and the median (408) of the data are the same. However, in a skewed distribution, such as that shown in panel (410) of FIG. 4, the mode (404), the median (408), and the mean (406) are different. The mode is a convenient measure of central tendency in a skewed distribution because it is not affected by extreme data values or possible outliers. The modal filter may be applied to seismic data (202) to exclude simulated first arrivals that have been misidentified by a first arrival picking method. Further, in some embodiments, the simulated first arrivals that are excluded by the modal filter may be replaced by interpolating the non-excluded simulated first arrivals in adjacent seismic receivers (116). The filtered first arrivals may then be used in calculating the objective function E(m) in each iteration of the WTI procedure.

A seismic velocity model (219), and thus, a seismic image (230) of high resolution may be obtained if densely-recorded data is acquired by using closely-spaced shots and seismic receivers. For example, seismic waves with a bandwidth extending up to 100 Hz or more may resolve thin features. However, as discussed above, processing seismic data (202) may give erroneous results when the recorded wavefield is complex. The simultaneous arrivals of seismic waves may lead to misidentification of first arrivals and consequently, to incorrect seismic velocity models. An accurate seismic velocity model is a desired input to generate high-quality seismic images (230) that may be used to identify and determine geological attributes in the subsurface region of interest (102).

As illustrated in FIG. 2, processing of seismic data (202) may generate a seismic image (230) that may reveal the two or three-dimensional geometry of a subsurface region of interest (102). In particular, the geological boundaries (236, 238) may delineate a hydrocarbon reservoir (104). Identifying geological boundaries (236, 238) and other geological objects, such as faults, may be performed using a seismic interpretation system. If a seismic image (230) indicates the potential presence of hydrocarbons in the subsurface region of interest (102), a wellbore (118) may be planned with a wellbore planning system. Further, a drilling system may drill a wellbore (118) to confirm the presence of those hydrocarbons.

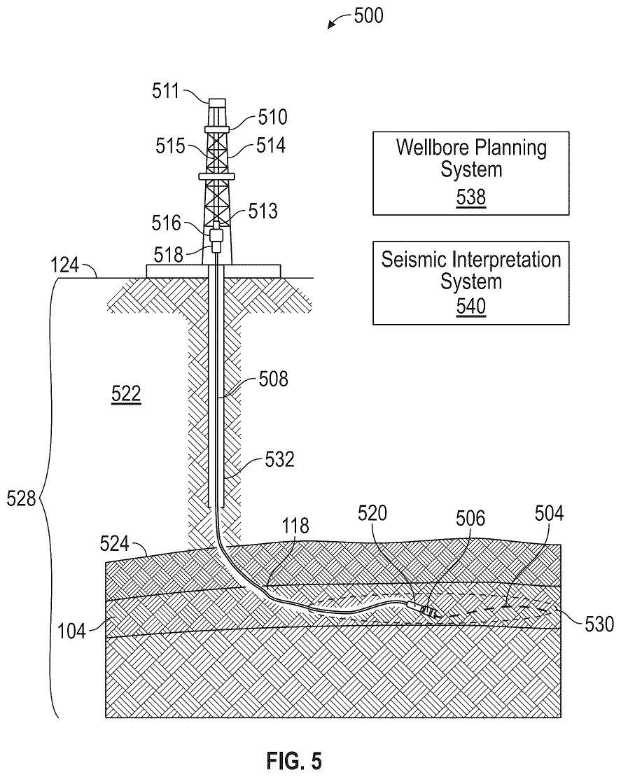

FIG. 5 shows a drilling system (500) in accordance with one or more embodiments. As shown in FIG. 5, a wellbore (118) following a wellbore trajectory (504) may be drilled by a drill bit (506) attached by a drillstring (508) to a drilling rig (510) located on the surface (124) of the earth. The drilling rig (510) may include framework, such as a derrick (514) to hold drilling machinery. A crown block (511) may be mounted at the top of the derrick (514), and a traveling block (513) may hang down from the crown block (511) by means of a cable (515) or drilling line. One end of the cable (515) may be connected to a drawworks (not shown), which is a reeling device that may be used to adjust the length of the cable (515) so that the traveling block (513) may move up or down the derrick (514).

A top drive (516) provides clockwise torque via the drive shaft (518) to the drillstring (508) in order to drill the wellbore (118). The drillstring (508) may comprise a plurality of sections of drillpipe attached at the uphole end to the drive shaft (518) and downhole to a bottomhole assembly (“BHA”) (520). The BHA (520) may be composed of a plurality of sections of heavier drillpipe and one or more measurement-while-drilling (“MWD”) tools configured to measure drilling parameters, such as torque, weight-on-bit, drilling direction, temperature, etc., and one or more logging-while-drilling (“LWD”) tools configured to measure parameters of the rock surrounding the wellbore (118), such as electrical resistivity, density, sonic propagation velocities, gamma-ray emission, etc. MWD and logging tools may include sensors and hardware to measure downhole drilling parameters, and these measurements may be transmitted to the surface (124) using any suitable telemetry system known in the art. The BHA (520) and the drillstring (508) may include other drilling tools known in the art but not specifically listed.

The wellbore (118) may traverse a plurality of overburden (522) layers and one or more seals or cap-rock formations (524) to a hydrocarbon reservoir (104) within the subterranean region (528), and specifically to a drilling target (530) within the hydrocarbon reservoir (104). The wellbore trajectory (504) may be a curved or a straight. All or part of the wellbore trajectory (504) may be vertical, and some portions of the wellbore trajectory (504) may be deviated from the vertical or horizontal. One or more portions of the wellbore (118) may be cased with casing (532) in accordance with a wellbore plan.

To start drilling, or “spudding in” the well, the hoisting system lowers the drillstring (508) suspended from the derrick (514) towards the planned surface location of the wellbore (118). An engine, such as an electric motor, may be used to supply power to the top drive (516) to rotate the drillstring (508) through the drive shaft (518). The weight of the drillstring (508) combined with the rotational motion enables the drill bit (506) to bore the wellbore (118).

The drilling system (500) may be disposed at and communicate with other systems in the well environment, such as a seismic processing system (220), a seismic interpretation system (540), and a wellbore planning system (538). The drilling system (500) may control at least a portion of a drilling operation by providing controls to various components of the drilling operation. In one or more embodiments, the drilling system (500) may receive well-measured data from one or more sensors and/or logging tools arranged to measure controllable parameters of the drilling operation. During operation of the drilling system (500), the well-measured data may include mud properties, flow rates, drill volume and penetration rates, rock physical properties, etc.

A seismic interpretation system (540) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs.

Interpreters may pick and interpret key geological horizons within seismic data to identify stratigraphic layers, boundaries, and structural features. Horizon interpretation tools and workflows allow for the accurate extraction of geological information from seismic volumes. A seismic interpretation system (540) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (540) to build 3D geological models by integrating seismic data with well-log data, geological knowledge, and other geophysical information. These models help in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (540) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

The seismic interpretation system (540) are essential tools for geoscientists involved in exploration and production activities, helping them make informed decisions about drilling locations, optimize production strategies, and understand complex subsurface geological structures. The seismic interpretation system (540) may be a specialized computer system used by geoscientists and seismic interpreters for analyzing and interpreting seismic data. The seismic interpretation system (540) may be implemented on a computing device such as that shown in FIG. 13.

Seismic interpretation involves intensive tasks like data visualization, horizon picking, attribute analysis, and 3D modeling. A high-performance seismic interpretation system (540) with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (540) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (540) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. Additionally, color-calibrated and high-accuracy input devices enhance the precision of interpretation tasks like picking horizons or drawing geological features. The seismic interpretation system (540) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (540) or collaborate with colleagues remotely. Setting up remote access capabilities, such as Virtual Private Networks (VPNs) or remote desktop solutions, allows interpreters to work from different locations and share their work effectively. The seismic interpretation system (540) may be customized to meet the needs of interpreters and the specific requirements of projects. The hardware specifications may vary based on factors like the complexity of interpretations, the size of datasets, and the software tools utilized.

In some embodiments, rock physical properties may be used by the seismic interpretation system (540) to determine a location of a hydrocarbon reservoir (104) (or other subterranean features), including the drilling target (530). Knowledge of the existence and location of the hydrocarbon reservoir (104) and other subterranean features may be transferred from the seismic interpretation system (540) to a wellbore planning system (538). The wellbore planning system (538) may use information regarding the hydrocarbon reservoir (104) location to plan a well, including a planned wellbore trajectory (504) from the surface (124) of the earth to penetrate the hydrocarbon reservoir (104). In addition, to the depth and geographic location of the hydrocarbon reservoir (104), the planned wellbore trajectory (504) may be constrained by surface limitations, such as suitable locations for the surface position of the wellhead, i.e., the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (504) may be transferred to the drilling system (500) described in FIG. 5. The drilling system (500) may drill the wellbore (118) along the planned wellbore trajectory (504) to access the drilling target (530) in the hydrocarbon reservoir (104).

A wellbore planning system (538) is used in the oil and gas industry for designing and planning drilling operations. It assists drilling engineers and teams in making strategic decisions related to wellbore placement, casing design, trajectory planning, and well path optimization. The wellbore planning system (538) allows drilling engineers to visualize and interact with wellbore data in a 3D environment. It provides a graphical representation of the planned well trajectory, existing well paths, geological formations, and potential hazards.

The wellbore planning system (538) integrates geological models, well logs, seismic data, and other subsurface information to facilitate the creation of accurate and realistic wellbore plans. By incorporating geological models, drilling engineers can optimize well placement in reservoir targets and avoid geohazards. Furthermore, the wellbore planning systems assist in designing optimal well trajectories based on reservoir targets, geologic constraints, and drilling objectives. Engineers can define well paths that maximize drilling efficiency, reach specific targets (horizontal or vertical), and account for geological formations and structural complexities.

The wellbore planning system (538) incorporates collision-avoidance algorithms to assess potential collision risks between nearby wells, salt bodies, or other subsurface infrastructure. By considering uncertainties in subsurface data and drilling conditions, the wellbore planning system (538) may assess collision probabilities for planned well paths. This analysis helps in quantifying risks associated with collision potential and improving well placement decisions. The wellbore planning system (538) provides real-time alerts to prevent wellbore collisions and maintain drilling safety.

The wellbore planning system (538) helps drilling engineers in designing casing strings and selecting appropriate tubulars based on the wellbore conditions, planned drilling operations, and regulatory requirements. It considers factors such as pressure, temperature, well depth, formation properties, and casing load capacity. Furthermore, the wellbore planning system (538) performs torque and drag analysis to evaluate the forces and stresses acting on the drillstring during drilling operations. This analysis helps in identifying potential issues such as differential sticking, buckling, or limitations in the drilling equipment. The wellbore planning system (538) may have the capability to integrate real-time drilling data, such as downhole measurements, drilling parameters, and formation evaluation results. This integration allows engineers to monitor the drilling progress, make on-the-fly adjustments to the well plan, and optimize drilling efficiency. Furthermore, the wellbore planning system (538) provides tools for generating reports, exporting data, and documenting drilling plans and decisions. These reports can be shared with regulatory agencies, drilling contractors, and other stakeholders to ensure alignment and compliance throughout the drilling lifecycle.

The wellbore planning system (538) assists drilling engineers in designing optimal well trajectories, minimizing risks, and maximizing drilling efficiency. They integrate various subsurface data sources, perform complex analyses, and provide visualization tools to support informed decision-making in well planning and drilling operations.

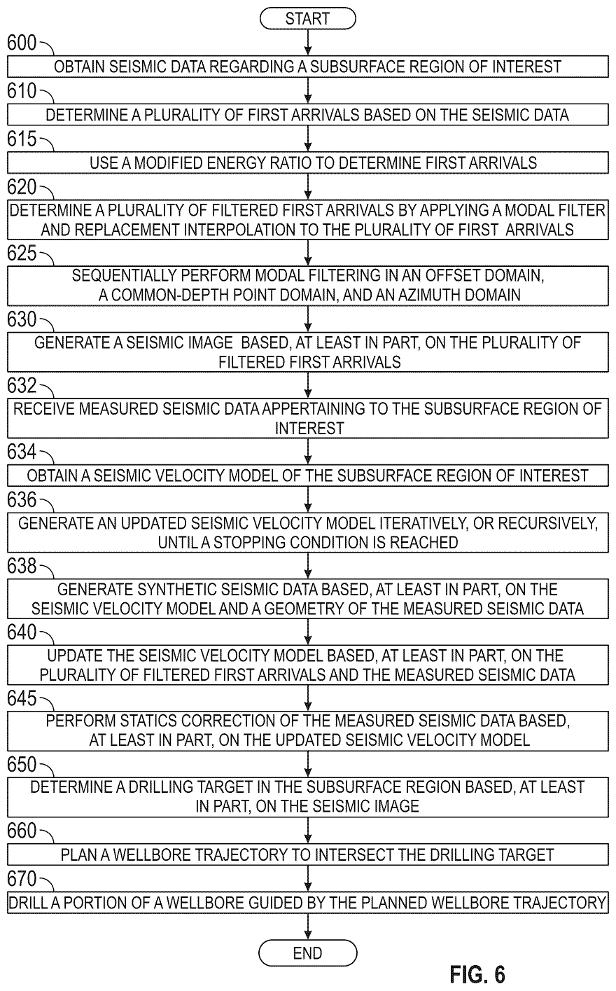

Turning to FIG. 6, FIG. 6 shows a flowchart in accordance with one or more embodiments. Specifically, FIG. 6 describes an embodiment of the inventive method to generate filter first arrivals to generate a seismic image, and further to plan and drill a wellbore to penetrate a target identified in the seismic image. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, seismic data (202) associated with a subsurface region of interest (102) is obtained, in accordance with one or more embodiments. The seismic data (202) may include a plurality of observed time-space waveforms (205). In some embodiments, the seismic data (202) may be acquired using a seismic acquisition system (100) above the subsurface region of interest (102). In other embodiments, the seismic data (202) may include synthetic seismic data. Synthetic seismic data may include time-space waveforms that are generated by numerical simulations of wave propagating in a model of the subsurface region of interest. The seismic data (202) may be processed to attenuate noise and may be organized in one or more spatial dimensions (216, 218) and a time axis (214) to form a plurality of time-space waveforms (205). In some embodiments, one or more CSGs (210) may be generated with the source position corresponding to the middle of the offset, as illustrated in FIG. 2. Furthermore, seismic data (202) may be arranged in different data domains. For example, the simulated time-space waveforms may be arranged in the offset domain, in the common depth-point domain, or in the azimuth domain.

In Block 610, a plurality of first arrivals is determined based on the seismic data (202), in accordance with one or more embodiments. Determining the first arrivals may be based upon variations in the statistical descriptions of the time-space waveforms, or upon variations in the energy ratio of time-windows of different lengths along the time-space waveforms. Alternatively, first arrivals may be determined using machine learning algorithms. In some embodiments, first arrivals are determined using the Modified Energy Ratio as shown in Block, 615.

In Block 620, a plurality of filtered first arrivals is determined by applying a modal filter and replacement interpolation to the plurality of first arrivals, in accordance with one or more embodiments. First arrivals may be filtered to exclude arrivals of late events, misidentified as first arrivals, that may introduce errors in seismic processing tasks. In some embodiments, the accuracy of identifying first arrivals may be further enhanced by excluding arrivals of late events in more than one data domain. For example, modal filtering may be performed sequentially in the offset domain, in the common depth-point domain and in the azimuth domain, as shown in Block 625.

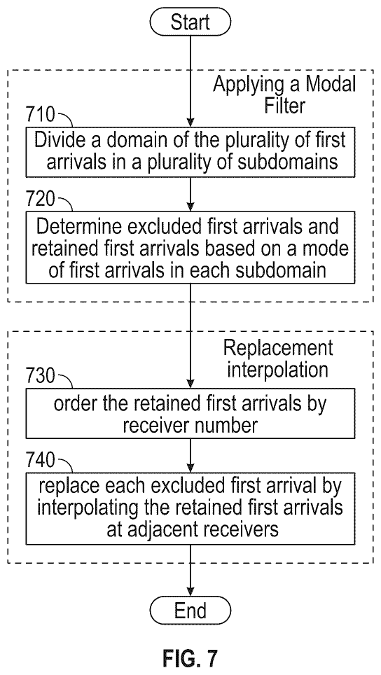

An example of a method for determining a plurality of filtered first arrivals is illustrated by the flowchart of FIG. 7, in accordance with one or more embodiments. The remaining steps of the method of FIG. 6 are presented below, after the discussion of FIG. 7. Turning to FIG. 7, in Block 710, the domain of the plurality of first arrivals may be divided in a plurality of subdomains. The size of each subdomain may be chosen by a user based upon experience or upon trial-and-error. As a non-limiting example, a subdomain of 100 m may be adopted in the offset domain. To improve accuracy the modal filter may then be applied to each subdomain to generate excluded first arrivals and retained first arrivals.

In some embodiments, excluded first arrivals and retained first arrivals may be determined based on a mode of first arrivals in each subdomain, as shown in Block 720. Applying the modal filter in each subdomain may include ordering the plurality of first arrivals of the subdomain in ascending order. Following the ordering, the plurality of first arrivals may be then divided in a plurality of bins. The plurality of bins may be determined based on the time values of the first arrivals. The number of bins may be a user's choice. As a non-limiting example, the subdomain may be divided in 10 bins. A selected bin may be selected from the plurality of bins, where the selected bin contains the highest number of first arrivals, statistically known as the mode. The first arrivals contained in the selected bin (and corresponding to the mode) may be the only first arrivals of the subdomain retained for the remaining processing steps. The first arrivals of the remaining bins may be considered as misidentified first arrivals, excluded first arrivals, and may be “filtered out” of the subdomain.

The excluded first arrivals may then be replaced with interpolated first arrivals, reducing in this way errors in first arrival picking. In some embodiments replacement interpolation may be performed in a time-receiver domain. The retained first arrivals may be ordered by receiver number, as shown in Block 730. Each excluded first arrival may then be replaced by interpolating the retained first arrivals at adjacent receivers, as shown in Block 740.

Returning to FIG. 6, in Block 630, a seismic image (230) is generated based, at least in part, on the plurality of filtered first arrivals, in accordance with one or more embodiments. The seismic image (230) may be determined based on a plurality of time-space waveforms (205) and the seismic velocity model (219). Various types of algorithms may be used in the generation of the seismic image (230).

In some embodiments, the seismic image (230) may be a migrated seismic image. The migrated seismic image may be generated with reverse time migration (RTM) using the two-way wave equation. In RTM, the source wavefield may be obtained by forward modelling the propagation of a synthetic source function using the seismic velocity model (219). A receiver wavefield may be generated using the same seismic velocity model (219) by backward propagating in time the receiver wavefield. In other words, the receiver wavefield may be first reversed in time and the used as a source function applied at the corresponding seismic receivers (116) to simulate a radiated wavefield.

The migrated seismic image may then be formed by applying an imaging condition to the receiver wavefield and the source wavefield. In some embodiments, the first imaging condition may be represented by a cross-correlation between the source wavefield with the receiver wavefield under the basic assumption that the source wavefield represents the down-going wave-field and the receiver wave-field the up-going wave-field. Furthermore, the seismic image (230) may be obtained by merging, or stacking, different partial migrated seismic images. Each partial migrated seismic image may be generated from seismic data (202) acquired upon activation of one or more seismic sources (106).

An accurate seismic velocity (219) model may be useful for the accurate generation of seismic images (230). A seismic velocity model (219) regarding the subsurface region of interest (102) provides an estimate of at least one seismic wave propagation velocity at each location in the depth domain within the subterranean region of interest (102). Typically, a seismic velocity model (219) is specified by at least one seismic velocity for a particular wave type at a plurality of discrete grid points spanning the subsurface region of interest, but other specifications are possible. For example, the seismic velocity model (219) may be defined by a plurality of continuously varying mathematical functions.

In some embodiments, a seismic velocity model (219) may be constructed by processing measured seismic data. Measured seismic data regarding the subsurface region of interest (102) may be recorded using a seismic acquisition system (100). A seismic processing system (220) may receive the measured seismic data appertaining to the subsurface region of interest (102), as shown in Block 632. In addition, the seismic processing system (220) may obtain a seismic velocity model (219) of subsurface region of interest (102), as shown in Block 634. Various types of algorithms may be used in the generation of the seismic velocity model (219). In some embodiments, processing measured seismic data to obtain a seismic velocity model (219) may be considered an inverse problem, where the applied process must determine the subsurface velocity model that resulted in the measured seismic data. WTI may be used for the processing of measured seismic data to form a seismic velocity model, that may be updated iteratively as part of the inversion.

In Block 636 an updated seismic velocity model (219) is generated iteratively, or recursively, until a stopping condition is reached, in accordance with one or more embodiments. Synthetic seismic data may be generated at each iteration to progressively approach or match one or more characteristics of the measured seismic data. In Block 638, the synthetic seismic data is generated based, at least in part, on the seismic velocity model and a geometry of the measured seismic data, in accordance with one or more embodiments. The synthetic seismic data may include time-space waveforms obtained from numerical simulations of wave propagation within the subsurface region of interest (102). In some embodiments numerical simulations are based on the elastic wave equation, or a simplified version of the elastic wave equation, such as the acoustic wave equation or Helmholtz wave equation, based at least in part on the seismic velocity model. In accordance with one or more embodiments, this modeling or seismic wave propagation and simulation of the seismic waves measured by the seismic receivers (116) may be done by the computer system (1300) of FIG. 13.

The seismic synthetic data may be generated using the geometry of the measured seismic data to allow the comparison of measured and simulated arrival times. For example, the locations of receivers relative to the source may be the same for the measured seismic data and the synthetic seismic data. Furthermore, the receivers of the seismic synthetic data may span the same range of midpoints and offsets as the measured seismic data.

In Block 640 the seismic velocity model is updated based, at least in part, on the plurality of filtered first arrivals and the measured seismic data, in accordance with one or more embodiments. Observed first arrivals may be determined from the measured seismic data. Further, the plurality of filtered first arrivals obtained from synthetic seismic data and the observed first arrivals may be compared using an objective function, such as for example, the objective functions of Equation (2). Updating the seismic velocity model (219) may be based on the minimization the objective function.

In addition, the objective function may be used to check the WTI for convergence, in accordance with one or more embodiment. The check for convergence may include evaluating the objective function and determining if the value of the objective function is below a preselected value, where the preselected value quantifies a satisfactory matching between the filtered first arrivals and the observed first arrivals. Alternatively, convergence may be determined by the iteration at which the value of the objective function ceases to decrease by more than a preselected amount between the current iteration and the previous iteration.

In some embodiments, convergence of the WTI may be considered as the stopping condition to be reached by the iterative process. If the WTI has converged the updated seismic velocity model may be designated as the final updated seismic velocity model, and the WTI process is terminated. If the WTI has not converged, then a new iteration is performed to generate a new updated seismic velocity model by repeating steps in Blocks 636-640.

In some embodiments, seismic data (202) may be processed to improve the accuracy of the seismic image (230). Specifically, an updated seismic velocity model with an enhanced accuracy may be used to perform “statics correction” in the seismic data (202), as shown in Block 645. Statics correction estimate and compensate for localized changes in the elevation of the ground surface on which the seismic data (202) is collected, and for localized changes of the seismic velocity close to the surface.

In Block 650 a drilling target in the subsurface region (102) may be determined using a seismic interpretation system (540) based, at least in part, on the seismic image (230). The seismic processing system (220) may transfer the seismic image (230) to a seismic interpretation system (540). The seismic interpretation system (540) may use the knowledge of the seismic image (230) to identify geological boundaries (236, 238) and geological structures. Examples of geological structures include, but are not limited to, faults, salt bodies and salt caverns. A drilling target (530) in a wellbore (118) may be determined by the seismic interpretation system (540), and may be based on, for example, an expected presence of gas or another hydrocarbon. Locations in a seismic image (230) may be delimited by geological boundaries (236, 238) and may indicate a probability of the presence of a hydrocarbon. Locations in a seismic image (230) may indicate an elevated probability of the presence of a hydrocarbon and may be targeted by well designers. On the other hand, locations in a seismic image (230) indicating a low probability of the presence of a hydrocarbon may be avoided by well designers.

In Block 660, a wellbore trajectory to intersect the drilling target may be planned, in accordance with one or more embodiments. Knowledge of the location of the drilling target (530) and the filtered seismic image may be transferred by the seismic interpretation system (540) to a wellbore planning system (538). Instructions associated with the wellbore planning system (538) may be stored, for example, in the memory (1309) within the computer system (1300) described in FIG. 13 below. The wellbore planning system (538) may use the knowledge of the location of the drilling target (530) and of the seismic image (230) to plan a wellbore trajectory (504) within the subterranean region of interest (102).

In Block 670, a portion of a wellbore may be drilled guided by the planned wellbore trajectory, in accordance with one or more embodiments. The wellbore planning system (538) may transfer the planned wellbore trajectory (504) to the drilling system (500) described in FIG. 5. The drilling system (500) may drill a portion of the wellbore (118) along the planned wellbore trajectory (504) to access and produce the hydrocarbon reservoir (104) to the surface (124).

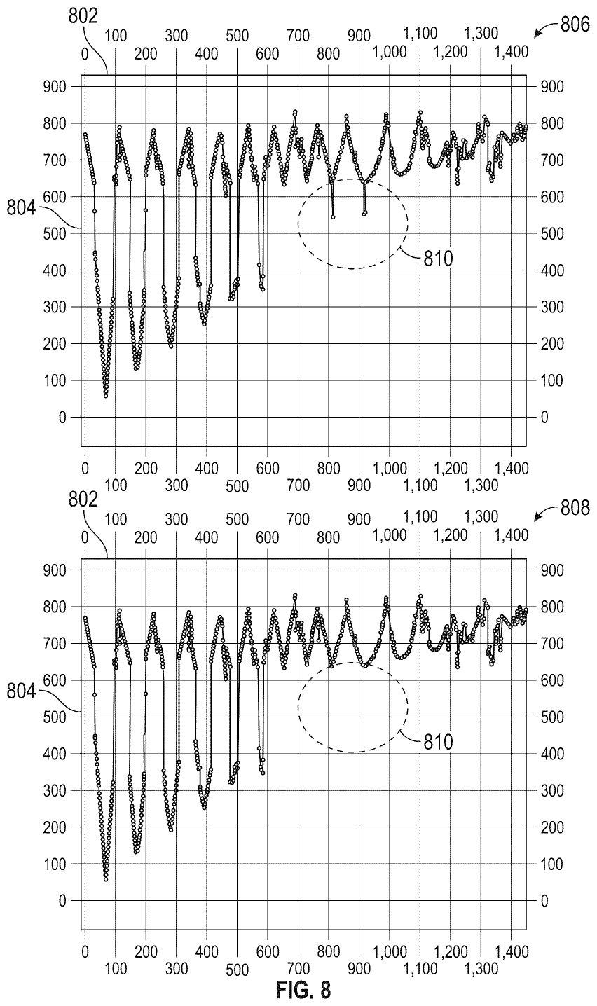

FIGS. 8-12 illustrate different stages in the processing of seismic data using the proposed method. Use of simulated data is common in the art and is advantageous at least because the solutions are known a priori. The example starts with a numerical representation of a simplified portion of the earth (the “model”). Then simulated data is generated from the numerical solution of the differential equation describing the physics of seismic wave propagation. Embodiments of the disclosed invention are applied to the simulated data and the results are compared with the model to assess the performance of the disclosed embodiments.

FIG. 8 shows an example of filtering simulated first arrivals in the time-offset domain, in accordance with one or more embodiments. The horizontal axis indicates the offset (802) and the vertical axis indicates the time (804) in milliseconds (ms). Panel (806) shows the simulated first arrivals before applying the modal filter, and panel (808) shows the simulated first arrivals after applying the modal filter. As seen, the modal filter filter-outs the arrivals enclosed by the ellipse (810), which, as seen panel (806), appear to be arrivals misidentified as first arrivals.

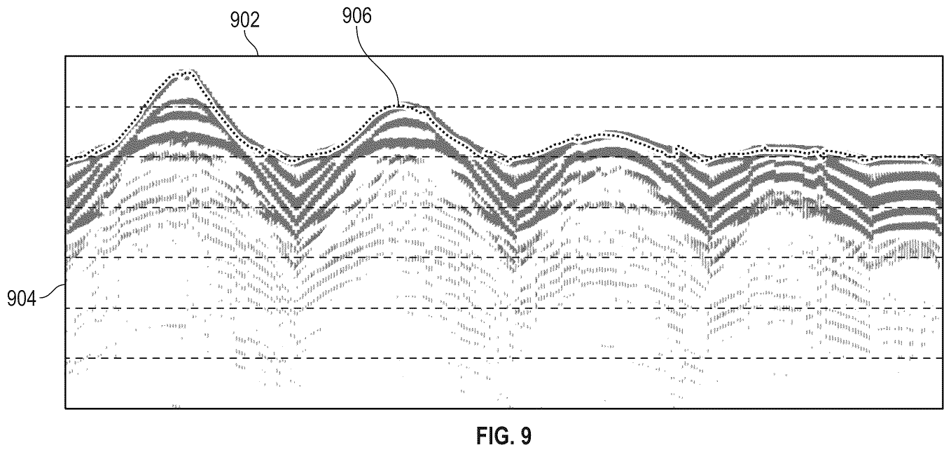

FIG. 9 shows an example of filtered simulated first arrivals in a simulated CDP gather, in accordance with one or more embodiments. The horizontal axis indicates the horizontal receiver position coordinate (902) and the vertical axis indicates time (904). The filtered first arrivals are obtained by applying the modal filter to the simulated CDP gather in FIG. 3. The discontinuous line indicates the filtered simulated first arrivals (906). By comparing with the simulated first arrivals (308), the filtered simulated first arrivals (906) show weaker discontinuities along the horizontal receiver position coordinate (902), indicating that later events misidentified as first arrivals have been removed.

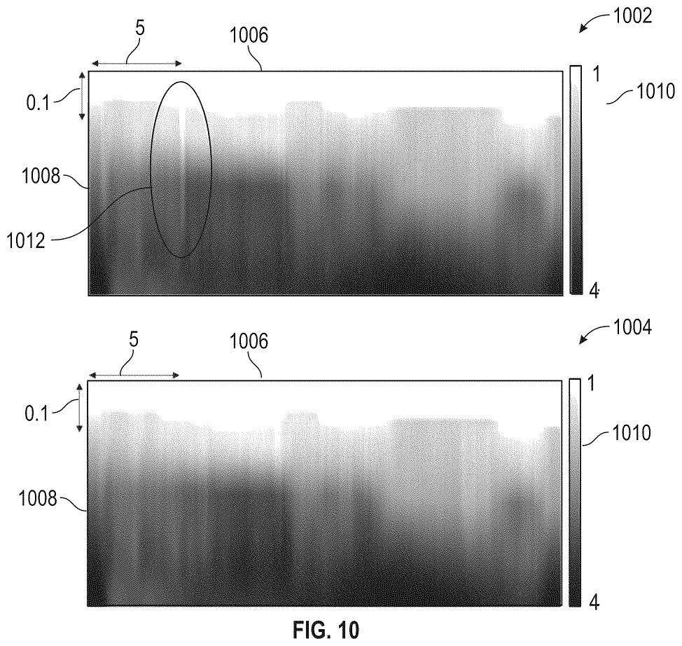

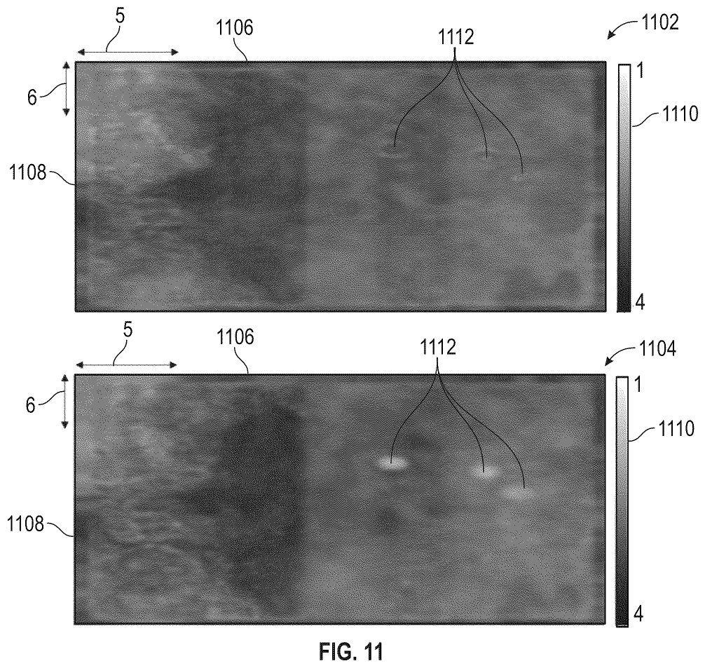

FIGS. 10 and 11 show examples of updated seismic velocity models that demonstrate the capabilities of the proposed method, according to one or more embodiments. Panels (1002) and (1004) in FIG. 10 correspond to a seismic velocity model generated with conventional WTI and with the proposed WTI with modal filtering, respectively. In both panels (1002, 1004) the horizontal axis indicates the horizontal coordinate (1006) and the vertical axis the vertical coordinate (1008). The amplitude of the seismic velocity is indicated by the bar scale (1010). In panel (1002) a strong discontinuity (1012) in the seismic velocity model can be observed, as indicated by the ellipse. The discontinuity (1012) is artificial and originates from the misidentified first arrivals. This observation is confirmed in panel (1004) obtained with WTI with modal filtering, where the discontinuity (1012) is not present.

FIG. 11 shows examples of horizontal slices of a seismic velocity model. Panels (1102) and (1104) in FIG. 11 correspond to a seismic velocity model generated with conventional WTI and with the proposed WTI with modal filtering, respectively. In both panels (1102, 1104) the horizontal axis indicates the horizontal coordinate (1106) and the vertical axis the vertical coordinate (1108). The amplitude of the seismic velocity is indicated by the bar scale (1110). Due to the higher accuracy of the seismic velocity of panel (1104) obtained with WTI with modal filtering, three velocity collapses (1112) are clearly distinguished, while in panel (1102) the velocity collapses (1112) are not as noticeable.

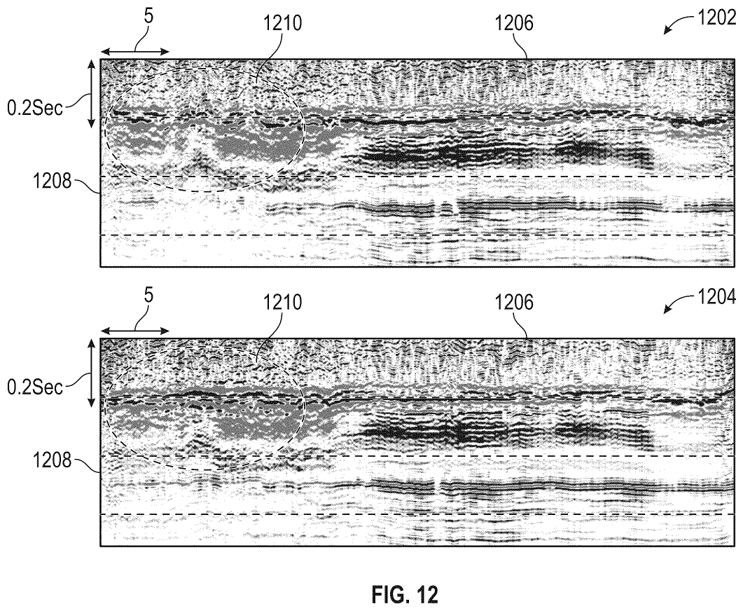

FIG. 12 shows examples of stacked images after static correction of the seismic data performed using the seismic velocity models of FIGS. 10 and 11, in accordance with one or more embodiments. Panels (1202) and (1204) in FIG. 12 correspond to stacked images after static correction of seismic data (202) using seismic velocity models generated with conventional WTI (1002, 1102) and with the proposed WTI with modal filtering (1004, 1104), respectively. In both panels (1202, 1204) the horizontal axis indicates the horizontal coordinate (1206) and the vertical axis indicates time (1208). When comparing the layers enclosed by the ellipse (1210) it can be observed that the layers in the ellipse (1210) in panel (1204) are more focused and have higher resolution than the layers in the ellipse (1210) in panel (1202). In addition, the layers in the ellipse (1210) appear to be flatter in panel (1202).

In some embodiments the wellbore planning system (538), the seismic interpretation system (540), and the seismic processing system (220) may each be implemented within the context of a computer system. FIG. 13 is a block diagram of a computer system (1300) used to provide computational functionalities associated with described algorithms, methods, functions, processes, flows, and procedures as described in the instant disclosure, according to an implementation. The illustrated computer (1300) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1300) may include a computer that includes an input device, such as a keypad, keyboard, touch screen, or other device that can accept user information, and an output device that conveys information associated with the operation of the computer (1300), including digital data, visual, or audio information (or a combination of information), or a GUI.

The computer (1300) can serve in a role as a client, network component, a server, a database or other persistency, or any other component (or a combination of roles) of a computer system for performing the subject matter described in the instant disclosure. The illustrated computer (1300) is communicably coupled with a network (1302). In some implementations, one or more components of the computer (1300) may be configured to operate within environments, including cloud-computing-based, local, global, or other environment (or a combination of environments).

At a high level, the computer (1300) is an electronic computing device operable to receive, transmit, process, store, or manage data and information associated with the described subject matter. According to some implementations, the computer (1300) may also include or be communicably coupled with an application server, e-mail server, web server, caching server, streaming data server, business intelligence (BI) server, or other server (or a combination of servers).

The computer (1300) can receive requests over network (1302) from a client application (for example, executing on another computer (1300)) and responding to the received requests by processing the said requests in an appropriate software application. In addition, requests may also be sent to the computer (1300) from internal users (for example, from a command console or by other appropriate access method), external or third-parties, other automated applications, as well as any other appropriate entities, individuals, systems, or computers.

Each of the components of the computer (1300) can communicate using a system bus (1303). In some implementations, any or all of the components of the computer (1300), both hardware or software (or a combination of hardware and software), may interface with each other or the interface (1304) (or a combination of both) over the system bus (1303) using an application programming interface (API) (1307) or a service layer (1308) (or a combination of the API (1307) and service layer (1308). The API (1307) may include specifications for routines, data structures, and object classes. The API (1307) may be either computer-language independent or dependent and refer to a complete interface, a single function, or even a set of APIs. The service layer (1308) provides software services to the computer (1300) or other components (whether or not illustrated) that are communicably coupled to the computer (1300). The functionality of the computer (1300) may be accessible for all service consumers using this service layer (1308). Software services, such as those provided by the service layer (1308), provide reusable, defined business functionalities through a defined interface. For example, the interface may be software written in JAVA, C++, or other suitable language providing data in extensible markup language (XML) format or other suitable format. While illustrated as an integrated component of the computer (1300), alternative implementations may illustrate the API (1307) or the service layer (1308) as stand-alone components in relation to other components of the computer (1300) or other components (whether or not illustrated) that are communicably coupled to the computer (1300). Moreover, any or all parts of the API (1307) or the service layer (1308) may be implemented as child or sub-modules of another software module, enterprise application, or hardware module without departing from the scope of this disclosure.

The computer (1300) includes an interface (1304). Although illustrated as a single interface (1304) in FIG. 13, two or more interfaces (1304) may be used according to particular needs, desires, or particular implementations of the computer (1300). The interface (1304) is used by the computer (1300) for communicating with other systems in a distributed environment that are connected to the network (1302). Generally, the interface (1304) includes logic encoded in software or hardware (or a combination of software and hardware) and operable to communicate with the network (1302). More specifically, the interface (1304) may include software supporting one or more communication protocols associated with communications such that the network (1302) or interface's hardware is operable to communicate physical signals within and outside of the illustrated computer (1300).

The computer (1300) includes at least one computer processor (1305). Although illustrated as a single computer processor (1305) in FIG. 13, two or more processors may be used according to particular needs, desires, or particular implementations of the computer (1300). Generally, the computer processor (1305) executes instructions and manipulates data to perform the operations of the computer (1300) and any algorithms, methods, functions, processes, flows, and procedures as described in the instant disclosure.

The computer (1300) also includes a memory (1309) that holds data for the computer (1300) or other components (or a combination of both) that may be connected to the network (1302). For example, memory (1309) may be a database storing data consistent with this disclosure. Although illustrated as a single memory (1309) in FIG. 13, two or more memories may be used according to particular needs, desires, or particular implementations of the computer (1300) and the described functionality. While memory (1309) is illustrated as an integral component of the computer (1300), in alternative implementations, memory (1309) may be external to the computer (1300).

The application (1306) is an algorithmic software engine providing functionality according to particular needs, desires, or particular implementations of the computer (1300), particularly with respect to functionality described in this disclosure. For example, application (1306) can serve as one or more components, modules, applications, etc. Further, although illustrated as a single application (1306), the application (1306) may be implemented as multiple applications (1306) on the computer (1300). In addition, although illustrated as integral to the computer (1300), in alternative implementations, the application (1306) may be external to the computer (1300).

There may be any number of computers (1300) associated with, or external to, a computer system containing computer (1300), each computer (1300) communicating over network (1302). Further, the term “client,” “user,” and other appropriate terminology may be used interchangeably as appropriate without departing from the scope of this disclosure. Moreover, this disclosure contemplates that many users may use one computer (1300), or that one user may use multiple computers (1300).

In some embodiments, the computer (1300) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining, using a seismic processing system, seismic data regarding a subsurface region of interest;
determining, using the seismic processing system, a plurality of first arrivals based on the seismic data;
determining, using the seismic processing system, a plurality of filtered first arrivals by applying a modal filter and replacement interpolation to the plurality of first arrivals; and
generating, using the seismic processing system, a seismic image based, at least in part, on the plurality of filtered first arrivals.

2. The method of claim 1, further comprising:
determining, using a seismic interpretation system, a drilling target in the subsurface region based, at least in part, on the seismic image; and
planning, using a wellbore planning system, a planned wellbore trajectory to intersect the drilling target.

3. The method of claim 2, further comprising drilling, using a drilling system, a portion of a wellbore guided by the planned wellbore trajectory.

4. The method of claim 1, wherein the seismic data comprises synthetic seismic data.

5. The method of claim 4, wherein generating the seismic image further comprises:
receiving, from a seismic acquisition system, measured seismic data appertaining to the subsurface region of interest;
obtaining a seismic velocity model of the subsurface region of interest; and
generating an updated seismic velocity model iteratively, or recursively, until a stopping condition is reached, wherein generating the updated seismic velocity model comprises:
generating the synthetic seismic data based, at least in part, on the seismic velocity model and a geometry of the measured seismic data, and
updating, using the seismic processing system, the seismic velocity model based, at least in part, on the plurality of filtered first arrivals and the measured seismic data.

6. The method of claim 1, wherein determining the plurality of first arrivals comprises using a modified energy ratio.

7. The method of claim 1, wherein applying the modal filter comprises sequentially performing modal filtering in an offset domain, a common depth-point domain, and an azimuth domain.

8. The method of claim 1, wherein by applying a modal filter comprises:
dividing a domain of the plurality of first arrivals in a plurality of subdomains; and
determining excluded first arrivals and retained first arrivals based on a mode of first arrivals in each subdomain.

9. The method of claim 8, wherein applying replacement interpolation comprises:
ordering the retained first arrivals by receiver number; and
replacing each excluded first arrival by interpolating the retained first arrivals at adjacent receivers.

10. The method of claim 5, further comprising performing statics correction of the measured seismic data based, at least in part, on the updated seismic velocity model.

11. A system comprising:
a seismic processing system configured to:
obtain seismic data regarding a subsurface region of interest, determine a plurality of first arrivals based on the seismic data,
determine a plurality of filtered first arrivals by applying a modal filter and replacement interpolation to the plurality of first arrivals, and
generate a seismic image based, at least in part, on the plurality of filtered first arrivals; and
a seismic interpretation system configured to receive the seismic image and to determine a drilling target in the subsurface region based, at least in part, on the seismic image.

12. The system of claim 11, further comprising:
a wellbore planning system, configured to plan a planned wellbore trajectory to intersect the drilling target.

13. The system of claim 12, further comprising a drilling system, configured to drill a portion of a wellbore guided by the planned wellbore trajectory.

14. The system of claim 11, wherein the seismic data comprises synthetic seismic data.

15. The system of claim 14, further comprising:
a seismic acquisition system configured to record measured seismic data regarding the subsurface region of interest;
wherein the seismic processing system is further configured to:
receive the measured seismic data,
obtain a seismic velocity model of the subsurface region of interest, and
generate an updated seismic velocity model iteratively, or recursively, until a stopping condition is reached, wherein generating the updated seismic velocity model comprises:
generating the synthetic seismic data based, at least in part, on the seismic velocity model and a geometry of the measured seismic data; and
updating the seismic velocity model based, at least in part, on the plurality of filtered first arrivals and the measured seismic data.

16. The system of claim 11, wherein the seismic processing system is further configured to determine the plurality of first arrivals by using a modified energy ratio.

17. The system of claim 11, wherein the seismic processing system is further configured to sequentially perform modal filtering in an offset domain, a common depth-point domain, and an azimuth domain.

18. The system of claim 11, wherein the seismic processing system is further configured to:
divide a domain of the plurality of first arrivals in a plurality of subdomains; and
determine excluded first arrivals and retained first arrivals based on a mode of first arrivals in each subdomain.

19. The system of claim 18, wherein the seismic processing system is further configured to:
order the retained first arrivals by receiver number; and
replace each excluded first arrival by interpolating the retained first arrivals at adjacent receivers.

20. The system of claim 15, wherein the seismic processing system is further configured to perform statics correction of the measured seismic data based, at least in part, on the updated seismic velocity model.
